(19) United States
(12) Patent Application Publication
(10) Pub. No.: US 2006/0248458 A1
(43) Pub. Date: Nov. 2, 2006

(54) Method and apparatus for storing and retrieving data using ontologies

(76) Inventor: Yang Li, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/568,825

(22) PCT Filed: Aug. 20, 2004
(86) PCT No.: PCT/GB04/03583

§ 371 Date: Feb. 22, 2006

(30) Foreign Application Priority Data
Aug. 28, 2003 (GB) 0320205.8

(51) Int. Cl. G06F 3/00

(52) U.S. Cl. 715/700

(57) ABSTRACT

A method of storing service description documents in a computerised storage system in which each document is associated with at least one verb ontological node (204) and at least one noun ontological node (254), each verb ontological node having one or more links to other verb ontological nodes and each noun ontological node having one or more links to other noun ontological nodes whereby the verb nodes form a verb space (200) and the noun nodes form a noun space (250) and a method of retrieving service description documents from a plurality of service description documents stored in this way comprising the steps of: controlling a user interface to request from a user at least one verb request term (405) and at least one noun request term (410), associating the or each verb request term (405) with a corresponding verb node (204) and the or each noun request term (410) with a corresponding noun node (254), comparing the or each corresponding verb node (204) with the or each verb node (212, 214) associated with each of the stored service description documents, comparing the or each corresponding noun node (254) with the or each noun node (262, 266) associated with each of the stored service description documents, and selecting for retrieval zero or more of the stored service description documents on the basis of the comparison steps and controlling the user interface to inform the user of the selected documents to enable the user to retrieve one or more of the selected documents.

### FIELD OF THE INVENTION

The present invention relates to a method and apparatus for storing and retrieving data and in particular for storing and retrieving data representative of descriptions of, in particular, services offered to a user of the method or apparatus.

### BACKGROUND TO THE INVENTION

At present, there are a limited number of different strategies for storing large amounts of data and then enabling users to search through the stored data to retrieve data of interest. It is possible to categorise these strategies as falling somewhere between two extremes represented by the World Wide Web at one extreme and a tree structured directory at the other end of the extreme.

In the former, there is no structure in the way in which data is stored; in order to search through the stored data (and in particular web-pages or “documents” which typically contain significant amounts of text), a key-word based search engine is typically used.

A very simple key word search engine might simply trawl (or “crawl”) through stored documents looking for the key word or words being searched for and return all such documents which include the key word or words. However, to speed things up when there are a large number of stored documents, a more sophisticated search engine might generate an index in advance which indexes all of the stored documents according to the frequency with which certain key-words appear in a document (the documents being pre-processed and given a score in respect of each “key word” appearing in the document). A search then consists of searching through the index and returning those documents, or rather the identification of those documents, which have a sufficiently high frequency of occurrence of the keywords for which the search is being carried out.

The disadvantage of this strategy is that key words may have more than one meaning and so irrelevant documents may be returned by the search (corresponding to an undesired meaning of the key word). Similarly, a relevant document might be missed by the search because of the document using different terminology to that used in the search request.

When the documents are stored, however, in a logically ordered manner such as in a classified tree structured directory, then it is possible for a user simply to search through the directory until arriving at a leaf node in which documents deemed to be relevant to that node are stored. This strategy overcomes the problems mentioned above with respect to key word searching.

The downside of this strategy however, apart from the effort required to place each document in its correct place or places within the directory, is that a searcher might not find a relevant document if the searcher follows a different route through the directory tree to that envisaged by the person who stored the document in the first place.

In recent years, a large amount of research has been carried out into the use of ontologies. Ontologies are generally used to assist in integrating heterogenous legacy databases. They enable this by precisely defining what differently used terminologies in the different databases actually mean. For example, one database might refer to “model ID” and a second database might refer to the same category as “product”. An ontology mapping may then be used to map “model ID” in the first ontology to “product” in the second ontology thus enabling a search request formulated in the first ontology to also retrieve relevant data from the second database by translating the search request from the first ontology to the second, etc.

A large amount of research has also been conducted in recent years on the possibility of using “ontologies” in order to improve the accuracy of searches relying on a key-word based approach. As mentioned above, an ontology is a formal representation of the meanings of various terms used, typically within a limited knowledge domain. One example of an ontology is known as WordNet. This ontology attempts to represent all of the English language in a formalised way. Each word has one or more possible meanings associated with it and each meaning is then linked to other meanings of other words in a number of different ways (eg hyponyms, hypernyms, etc.). One way of improving the accuracy of a search using an ontology is to replace key-words in either or both of a search request and a target document with their meanings according to an ontology. The structure of the ontology can then be used to enhance the power of the search by searching not only for documents containing the same meanings as the meaning of the request but also for hyponyms thereof etc. (a hyponym is a specific type of or a specialisation of something, eg throwing knife and fish knife are hyponyms of knives, while knife is a hypernym of fish knife, etc.). A paper which discusses this approach is “OntoSeek: Content-Based Access to the Web” by Nicola Guarino, Caudio Masolo and Guido Vetere; published in IEEE INTELLIGENT SYTEMS publication MAY/JUNE 1999 edition pages, 70 to 80.

A commercially important application for storing documents ahd permitting users to search through the stored documents is for enabling service providers to find clients and vice versa. In such an application, service providers advertise their services within a directory or similar storage facility and users or would-be clients may search through the directory to attempt to find one or more service providers who are able to provide the desired service. Within such an application, each service provider typically provides a natural language description of the or each service which it is able to provide. With computerised systems, a user is then able to perform a key word search through these natural language descriptions in order to try to find a suitable service provider.

### SUMMARY OF THE INVENTION

According to a first aspect of the present invention, there is provided a method of searching through a plurality of stored documents, the method comprising: storing the plurality of documents; storing a representation of an ontology, the ontology comprising a plurality of inter-related nodes and being divided into at least two distinct sub-spaces; for each of the plurality of documents, storing at least one association with a node of a first distinct sub-space of the ontology and at least one association with a node of a second distinct sub-space of the ontology; controlling a user interface to permit a user to input up to at least two search terms using free text entry and to associate the or each search term with a respective distinct sub-space of the ontology; comparing the or each input search term with nodes of the corresponding sub-space only, in order to attempt to determine one or more possible matches or partial matches; and selecting one or more of the stored documents based on the or each possibly matched or partially matched node and the stored associations between the stored documents and the nodes of the ontology for presentation to the user.

It will be appreciated that this method is intended to be performed on a computer apparatus of some sort. For example, in a typical computer apparatus extant at the time of filling the application, the storing may be performed on a digital storage medium such as a hard disk drive, the control of the user interface and the comparison and selection steps may be performed by a suitably programmed computer processor system, etc. Indeed, the above set out method addresses the problem created by the storage of documents by computers rather than using a human administrator to store and retrieve documents.

Computers are notoriously bad at determining context of free text inputs and as a result often produce spurious results when free text inputs are allowed. By providing an ontology with multiple distinct sub-spaces (where a search for a node in one sub-space will not produce as a match or partial match a node in another distinct sub-space) and allowing a user to search separately in the distinct sub-spaces, the problem of bad context can be mitigated to some extent whilst still providing the user with the convenience of being able to enter free text key-word type search terms.

Thus a request for a document to a human library administrator along the lines of “I'm interested in finding out documents about building restaurants and people providing restaurant building services” would be unambiguous and the human librarian would probably have no difficulty locating relevant documents. The same request to a computer system however would probably select lots of irrelevant documents along with (possibly) a few relevant ones. One problem with the request is that the term building is more commonly used as a noun rather than as a verb as it is intended in this example. In an embodiment of the present invention there could be two nodes for building, one in a verb sub-space of the ontology and one in a noun sub-space, etc.

According to a second aspect of the present invention, there is provided a method of storing service description documents in a computerised storage system in which each document is associated with at least one verb ontological node and at least one noun ontological node, each verb ontological node having one or more links to other verb ontological nodes and each noun ontological node having one or more links to other noun ontological nodes whereby the verb nodes form a verb space and the noun nodes form a noun space.

The term “service description document” is used to indicate data in any format which, after suitable processing if necessary, includes a human or machine readable description of a particular service offered by the party which “owns” the service description document. Note that the service could be one offered by one machine to another (eg to enable an “agent” (ie a computer program operating with a degree of self-autonomy) to carry out a complex task by automatically searching for and requesting sub-steps of the complex task to be performed by other devices).

Preferably, the method additionally includes associating each service description document with one of a plurality of possible different relationship types expressing the relationship between the or each pair of the at least one verb node and the at least one noun node. Preferably, the possible relationship types are: input-of where the service described in the service description document takes an object corresponding to the associated noun node as an input of the service, output-of where the service described in the service description document takes an object corresponding to the associated noun node as an output of the service, or related-to as a default relationship for cases where no other relationship is specified or where neither of the above options seems appropriate.

Preferably, the number of verb nodes with which a service description document is associated is one and the number of noun nodes is either one or two.

According to a third aspect of the present invention, there is provided a method of retrieving service description documents from a plurality of service description documents stored according to the second aspect of the present invention, the method comprising the steps of:

controlling a user interface to request from a user at least one verb request term and at least one noun request term,

associating the or each verb request term with a corresponding verb node and the or each noun request term with a corresponding noun node,

comparing the or each corresponding verb node with the or each verb node associated with each of the stored service description documents,

comparing the or each corresponding noun node with the or each noun node associated with each of the stored service description documents, and

selecting for retrieval zero or more of the stored service description documents on the basis of the comparison steps and controlling the user interface to inform the user of the selected documents to enable the user to retrieve one or more of the selected documents.

Preferably, the user interface is additionally controlled to obtain from the user information specifying a relationship type between the input noun and verb request terms, and this is also compared with the or each associated relationship type of each of the stored service description documents.

The present invention provides significant advantages over currently known methods of performing document search and retrieval. In particular, the use of a verb and noun or a noun, verb and noun as a search request makes for an intuitively simple search request for a user to generate and yet provides a large amount of information. Furthermore, for the purposes of locating a service, it is a particularly suitable form for a search request to take. Furthermore, by associating each document with at least two nodes in different ontological spaces (ie a verb space and a noun space), and additionally with a relationship between each noun and verb node, a very accurate description of a service can be made which is still very intuitive and easy to predict by an inexpert user.

More generally, the invention provides for associating stored documents with two (or more) distinct identifier terms, each of which is associated with its own distinct ontological space. The retrieval of documents can then be performed efficiently by carrying out two (or more) separate searches in the distinct (and specific) ontological spaces. By making the ontological spaces specific to the type of identifier, they contain fewer nodes than they would if general ontological spaces were used and therefore the searches are more likely to be accurate. But by having more than one ontological space (and thus search) the range of different distinct ways of describing/identifying documents can be increased without losing accuracy. Including as part of the identification/searching strategy a type of link or links between the various identifier terms further increases both possible accuracy and “resolution”. Note that the use of specific ontological spaces (which could perhaps be termed limited ontological spaces, or simply limited ontologies) is especially beneficial because of the high levels of accuracy and flexibility which limited ontologies provide for indexing and searching.

According to a fourth aspect of the present invention, there is provided a system for permitting a plurality of documents to be stored and subsequently searched through and selectively retrieved, the system including a data store for storing the plurality of documents; a plurality of data items representing nodes in an ontology, the nodes being categorised into at least two sub-groups representing two distinct sub-spaces within the ontology; and also at least two associations in respect of each document between the document and a node in one sub-group and the document and a node in another subgroup; the system further including a user interface arrangement for permitting a user to search for one or more documents amongst the plurality of stored documents, the user interface being arranged to permit the user to enter one or more search terms using free text entry and to associate the or each search term with one of the distinct sub-spaces within the ontology; and the system further comprising a processor arrangement which is operable to compare each search term with the data items representing nodes categorised into the same sub-space of the ontology as that with which the user has associated the search term to identify possible matches or partial matches with one or more nodes within the sub-space, and to select and return documents as the result of the search in dependence upon the nodes matched up with the search term or terms entered by the user and the nodes associated with the plurality of stored documents.

Preferably, the selection of documents uses relationships between nodes within the distinct ontology sub-spaces, including sibling-of, child-of and parent-of relationships, in order to select documents which are associated with nodes which are closely related to nodes matched to the search terms in addition to documents which are associated directly with nodes matched to the search terms.

According to a fifth aspect of the present invention, there is provided a data store, for use in the system of the third aspect of the present invention, as set out in claim 11.

Further preferred features of the present invention are set out in the appended dependent claims.

### BRIEF DESCRIPTION OF THE FIGURES

In order that the present invention may be better understood, embodiments thereof will now be described, by way of example only, with reference to the accompanying drawings in which:

FIG. 1 is a block diagram of an embodiment of the present invention in general overview;

FIG. 2 is a schematic illustration of the graphical user interface employed on the user terminal of the embodiment of FIG. 1;

FIG. 3 is a block diagram of the ontology server of the embodiment of FIG. 1 shown in greater detail;

FIG. 4 is a schematic representation of a part of the ontology stored on the ontology server of FIG. 3 including two links, each link linking two of the nodes of the ontology and being associated with a service description stored in the data store of the embodiment of FIG. 1;

FIG. 5 is a schematic representation of four different ways of linking a “refurbish” action node with a “house” object node according to a representational methodology used in an embodiment of the present invention;

FIG. 6 is a schematic representation similar to FIG. 4 in which the diagram has been added to, to illustrate how a search request is matched to nodes of the ontology during a search; and

FIG. 7 is a flow chart of a method of selecting and retrieving matching service descriptions on the basis of an input request according to an embodiment of the present invention.

### DETAILED DESCRIPTION OF THE FIRST EMBODIMENT

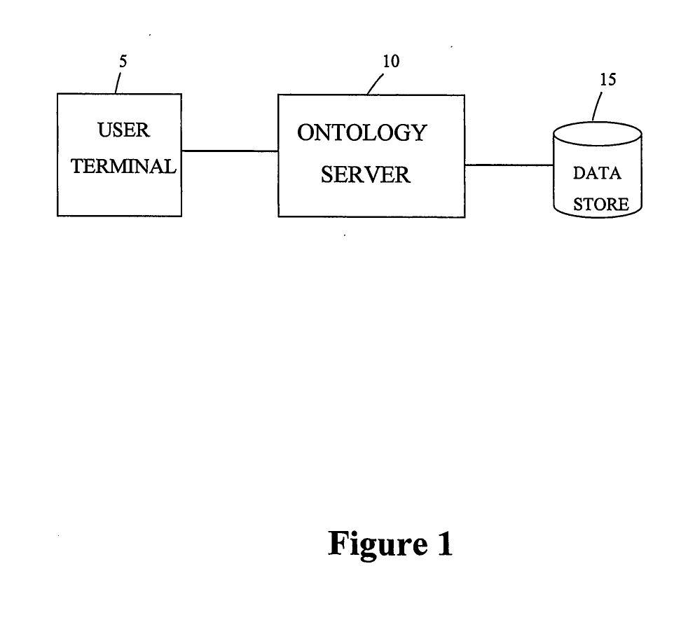

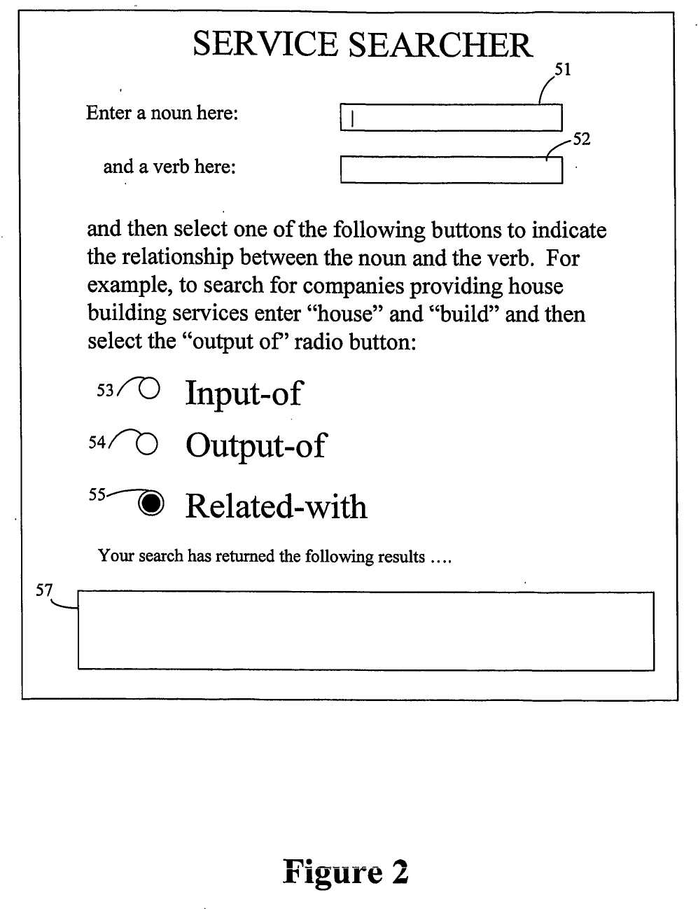

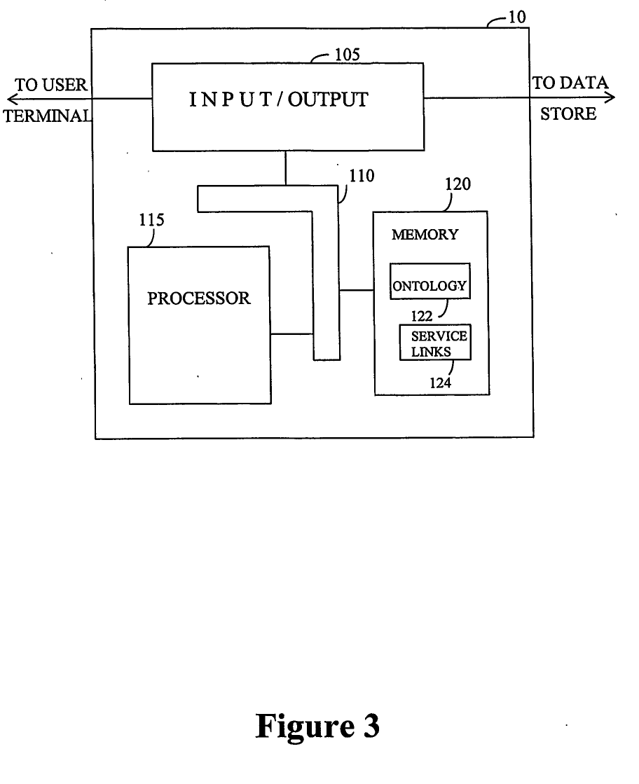

FIG. 1 illustrates in overview apparatus for storing and retrieving service descriptions. The apparatus comprises a user terminal 5, an ontology server 10 and a data store 15. In operation, a user enters a service description search request in a manner controlled to a certain extent by the particular graphical user interface employed by the user terminal (and described in greater detail below with reference to FIG. 2) to the user terminal 5. The user terminal 5 then transmits the request to the ontology server 10 which is connected to the user terminal by a data communications network. The ontology server 10 processes the request (in a manner described in greater detail below with reference to FIGS. 3 to 7) and selects zero or more matching service descriptions stored in the data store 15. The selected service descriptions are then transmitted to the user terminal which displays these to the user as the results of the user's search query.

Referring now to FIG. 2, the user interface employed in the present embodiment includes two text entry boxes 51, 52 into which the user is invited to enter a noun and a verb respectively (note that these are simple “free-text” entry boxes into which the user may type any key-word as desired without any constraint, such as having to choose from a list of allowed keywords). Located beneath the text boxes are three radio buttons 53, 54, 55 which are designated “Input of”, “Output of” and “Related with” respectively. The radio buttons have the property (as is well known in the art) that exactly one of the buttons must be selected at any one time, such that if a user selects a different one of the radio buttons to that which is currently selected, the currently selected button is automatically unselected. In the present embodiment, the “Related with” button is selected by default. Additionally, the user interface in the present embodiment includes some text to guide the user as to what should be done to formulate a search request which reads “Enter a noun here . . . [noun text box 51] and a verb here . . . [verb text box 52] and then select one of the following buttons to indicate the relationship between the noun and the verb. For example, to search for companies providing house building services, enter “house” and “build” and then select the “output of” radio button.”

In the present embodiment, the user interface additionally includes a results space 57 in which selected service descriptions generated by the apparatus are displayed to the user underneath the following illustrative text “your search has returned the following results: . . . ”

Referring now to FIG. 3, the ontology server 10, in the present embodiment, is schematically shown as including an input/output unit 105, a system bus 110, a processor arrangement 115 and a system memory 120. As is well known in the art, the system bus interconnects the other principal components 105, 115, 120 of the server together so that any one component may communicate with any other. The input/output unit 105 enables the server to receive search requests from, and to return search results to, the user terminal 5, as well as to read data from the data store 15, under the control of the processor 115. The memory 120 as well as storing a program for controlling the overall operation of the ontology server 10 additionally includes an ontology storing area 122 for storing an ontology and a service links storing area 124 for storing a plurality of service links which are discussed in greater detail below.

It will be apparent to the skilled reader that FIG. 3 and the above description of FIG. 3 are very high level representations of the server in which the details of the server computer have deliberately been omitted for the sake of clarity. Except as set out in this document, the server can be any suitable conventional server computer the constitution and operation of which is well known in the art.

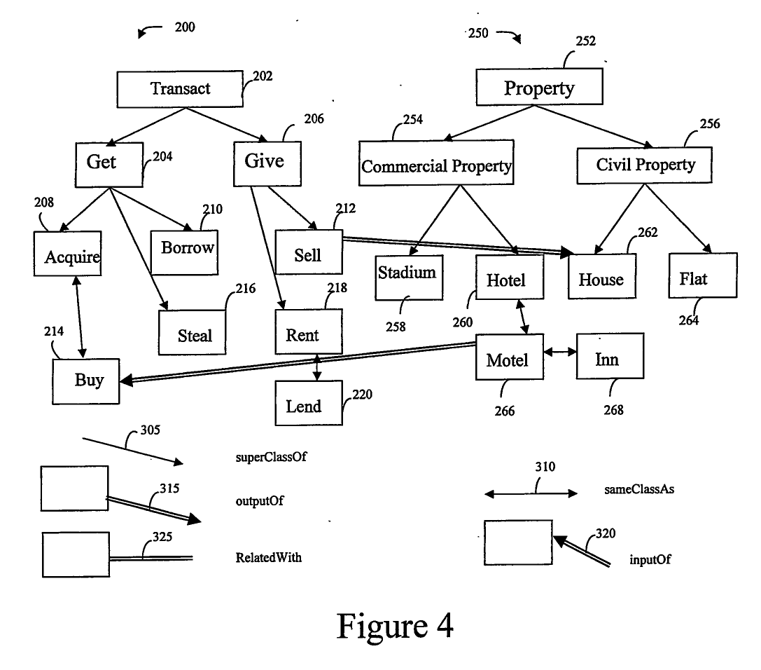

FIG. 4 illustrates a part of the ontology stored in the ontology server 10. Each box (202-220 & 252-268) containing a word or words represents a node of the ontology, each single lined arrow represents a relationship between the thus connected nodes and each double lined arrow represents a link between the thus linked nodes. The nodes on the left-hand-side of the figure (202-220) which are connected to one another are verb (also called action) nodes whilst the nodes (252-268) which are connected together on the right-hand-side of the figure are noun (also called object) nodes. The double lined arrow links link a noun node to a verb node.

As illustrated in the key underneath the connected boxes of the illustrated part of the ontology, the single arrow-headed relationship lines (305) indicate a super-class-of/sub-class-of relationship where the node to which the arrow-head points is designated as a sub-class relative to the node away from which the arrow-head points; for example, both “Get” (204) and “Give” (206) are designated as sub-classes of “Transact” (202). The rationale for designating a node as a subclass of another node is that a first node can be designated as a sub-class of second node if each specific example case falling within the concept designated by the first node also falls within the concept designated by the second node, but not all specific example cases falling within the concept of the second node also fall within the concept of the first node.

The double arrow-headed relationship lines (310) indicate a same-class-as relationship whereby both nodes connected by the relationship line are designated as being in the same class as one another; for example, “Acquire” (208) and “Buy” (214) are designated as having a same-class-as relationship to one another. The rationale for designating two nodes as being in the same class as one another is that each specific example case falling within the concept of one node should also fall within the other and vice versa. Note that this is determined by the ontology designer for the purposes of the particular ontology, which, in the present embodiment, is to put prospective customers in touch with companies which provide the desired services. In the present embodiment, the designer has therefore decided that for these purposes Acquire and Buy are synonymous, even though for other purposes it might be that these represent different concepts with perhaps Buy being a sub-class of Acquire (since a person could arguably acquire an item without necessarily paying for it, whilst a person could not buy an item without so paying for it).

A single arrow-headed (but double-lined) link (315, 320) indicates an Input-of/Output-of link. A link (315, 320, 325) (indicated by a double lined arrow) always links a verb node to a noun node. If the arrow-head of an Input-of/Output-of link points away from a noun node towards a verb node, the link is an Input-of link (320) indicating that an associated service or service search request takes the noun node as an input. Conversely, if the arrow-head points towards a noun node from a verb node, then the link is an Output-of link (315) indicating that the associated service or service search request produces the noun node as an output. Double lined links with no arrow-head are Related-with links (325) which indicate that the associated service or service search request relates the linked verb and noun nodes to one another in an unspecified manner (ie either as an input, an output, both an input and an output or any other case where the object cannot really be considered to be either an input or an output).

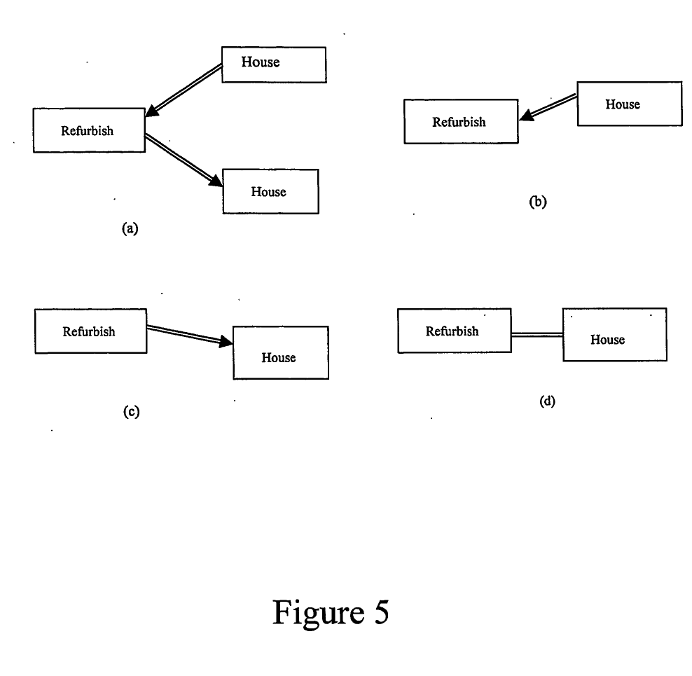

FIGS. 5b-5c illustrate the three possible ways in which two nodes can be linked together in the present embodiment in which each stored service or service search request is associated with a link which comprises only one noun node, one verb node and one relationship therebetween. FIG. 5a illustrates how these two nodes could be linked together in an alternative embodiment in which each link associated with a stored service or service search request can comprise both an input noun node and an output noun node. FIG. 5a thus shows the case where, in an alternative embodiment, the noun node “House” is both an input of and an output of the offered service of house refurbishment. FIG. 5b shows the case according to the present embodiment in which the noun node “House” is designated as an input to the house refurbishment service, FIG. 5c illustrates the case where the noun node “House” is designated as the output of the house refurbishment service, and FIG. 5d illustrates the case where the noun node “House” is merely designated as being related with the verb node “Refurbish” to indicate that the concepts/specific items covered by the noun node “House” are in some unspecified manner related with the offered service of house refurbishment. Note that in the case of house refurbishment all of the above links are reasonable designations. On this basis, the best option in the present embodiment where the designation of FIG. 5a is not possible, is probably the related with designation illustrated in FIG. 5d.

In the present embodiment, the data store 15 contains a plurality of records each of which corresponds to a service which the associated service supplier is offering to prospective clients. The record includes contact details for contacting the supplier and a description written in a natural language of the service offered.

Additionally, the ontology server 10 also stores a corresponding list of links to form an index. The index, in the present embodiment, lists each of the records stored in the data store by some suitable identifier (to enable the identified record to be retrieved from the data store 15) together with a link associated with that record. In the present embodiment, the link comprises a noun node, a verb node and a relationship (either Input-of, Output-of or Related-with). In the present embodiment, the link for each record is preferably formed by asking each supplier to provide this information in respect of each record associated with it. To assist the supplier in this task, it is given read-only access to the ontology stored on the ontology server together with appropriate navigational software to permit the supplier to traverse through the ontology to find the most appropriate nodes to select. Alternatively, the ontology server administrator may also provide the information. This may be useful to get the system up and running in the first place.

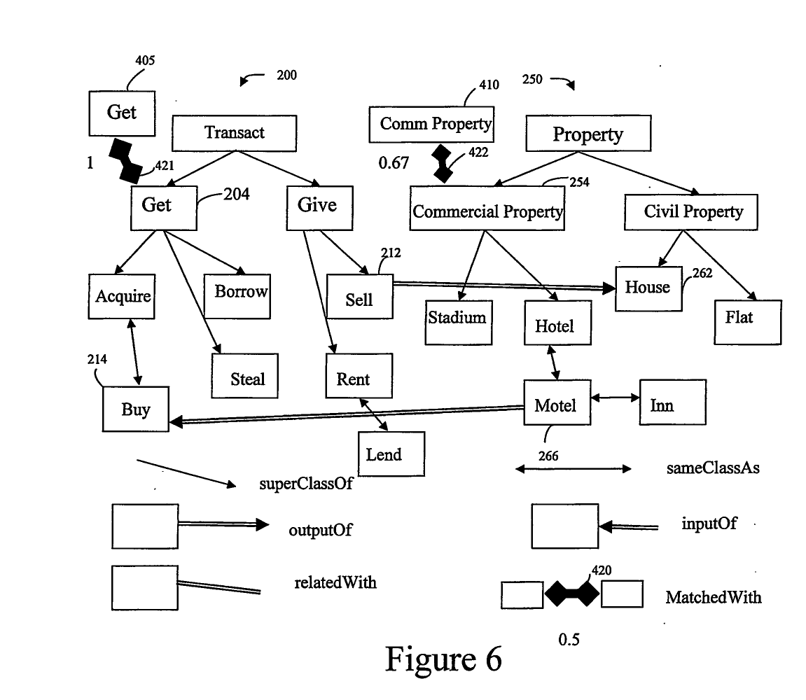

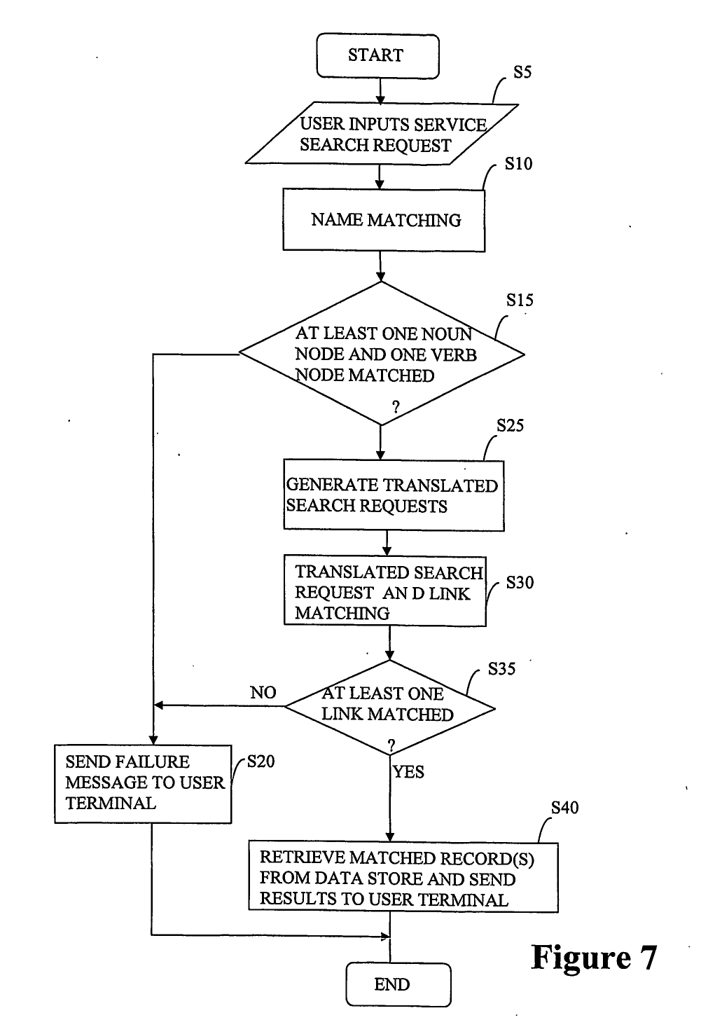

FIG. 6 shows the same part of the ontology as shown in FIG. 4 together with two boxes 405, 410 which indicate terms from a service search request which has been entered by a user of terminal 5 via the user interface illustrated in FIG. 2. The two terms 405, 410 are shown as having been matched to nodes 204 and 254 by matching connections 421, 422 with degrees of matching of 1.0 and 0.48 respectively. Furthermore, FIG. 6 includes in the key part a generic “matched with” connection symbol 420. The way in which terms of a service search request are matched to nodes in the stored ontology is now discussed in greater detail below with reference to all of the figures, but with particular reference to the flow diagram of FIG. 7.

Thus, referring now to FIG. 7, the first step in the method of using the apparatus of FIG. 1 to retrieve one or more service records of interest from the data store 15 is for the user to enter a search request at step S5 using the user interface illustrated in FIG. 2. This service search request is then transmitted to the ontology server 10 where it is further processed according to the following steps.

In step S10, the ontology performs name matching between the terms of the received service search request and the names of the nodes of the ontology stored in the ontology server. The purpose of this step is to enable a user to freely type into the user interface any terms of his choosing which are then associated with terms used in the ontology rather than selecting possible options directly from the ontology. Any suitable method for performing this task may be used. The particular way in which this is done in the present embodiment, however, is described in greater detail below after describing in overview the method illustrated in FIG. 7. The result of the name matching step is to determine all of the verb nodes (Aᵢ, where 1≦i≦a and a is the number of matched verb nodes, if any) of the ontology which can be matched with the verb part of the input service search request together with the verb matching correlation (CF(Aᵢ)) of each matched verb node and all of the noun nodes (Pⱼ, where 1≦j≦p and p is the number of matched noun nodes, if any) of the ontology which can be matched with the noun part of the input service search request together with the noun matching correlation (CF(Pⱼ)) of each matched noun node.

Upon completion of step S10, the method proceeds to step S15 in which it is determined if both at least one noun node and at least one verb node have been matched with the noun and verb terms of the service search request respectively. If either no noun nodes or no verb nodes can be matched with the service search request, the method proceeds to step S20 in which a response is sent back to the user terminal 5 informing the user that no search results have been found and inviting the user to try again with different search terms and then the method ends. If, however, at least one noun node (Pⱼ) and at least one verb node (Aᵢ) are matched, then the method proceeds to step S25.

In step S25, the ontology server forms a plurality of translated service requests (Aᵢ, Pⱼ, R, CF(Aᵢ), CF(Pⱼ)) by taking each possible combination of a matched verb node with a matched noun node and linking these together according to the relationship (R) between noun term and verb term expressed in the original service search request. For example in the case that the input service search request by the user is “Get” for the verb term, “Comm_Property” for the noun term and the specified relationship is Input-of, and only a single verb node, the “Get” verb node 204, and a single noun node, the “CommercialProperty” node 254, are matched therewith, then only a single translated search request is formed, namely (Aᵢ=“get”, Pⱼ=“CommercialProperty”, R=Input-of, CF(Aᵢ)=1.0, CF(Pⱼ)=0.48, i=a=j=p=1). Note that the manner in which CF(Aᵢ) and CF(Pⱼ) are calculated is explained in greater detail below when discussing name matching.

Having generated the translated search requests in step S25, the method proceeds to step S30 in which each translated search request is compared with each link in the index stored in the service links storage area 124. The links for which a matching score is determined to be above a predetermined threshold are selected and then the method proceeds to step S35. The particular way in which the comparison is performed in the present invention is set out below using pseudo-code under the heading “Translated Search Request and Link matching.”

Upon completion of step S30, the method proceeds to step S35 in which it is determined whether at least one link and associated record (the actual record or records being stored in the data store 15) was selected in step S30. If not, the method proceeds to step S20 in which a response is sent back to the user terminal 5 informing the user that no search results have been found and inviting the user to try again with different search terms and then the method ends. If, however, at least one link and associated record was selected in step S30, then the method proceeds to step S40 in which the or each selected record is retrieved from the data store 15 and then sent as part of a results message to the user terminal 5 where the results are displayed to the user in the results space 57 of the graphical user interface illustrated in FIG. 2.

Upon completion of step S40, the method ends.

The details of how the name matching step S10 and the translated search request and link matching step S30 in the present embodiment are now described.

Name Matching (Step S10)

The purpose of this step is to match the noun and verb parts of the search request (freely entered by a user at the user terminal into text boxes 51 and 52 of the user interface of FIG. 2 respectively) with corresponding noun and verb nodes in the ontology stored in the ontology server 10. In the present embodiment, this is done using three matching rules (a direct matching rule, an atomic name matching rule and a compound name matching rule) each of which takes two terms (A,B) as input and outputs a degree of matching (CF(A,B)) which is zero if the terms are not matched by the rule and a value between zero (but obviously not including zero itself) and one (including one itself) in the event that they are matched to some extent, a value of one indicating a complete match.

The direct matching rule simply compares the two input terms and, disregarding any punctuation marks, spaces, etc as well as differences in the cases (eg upper and lower) of the letters appearing in the two terms, outputs a matching degree, CF(A,B), of one if the terms are the same or zero otherwise.

The atomic name matching rule again disregards punctuation and capitalisation etc and proceeds by initially setting the matching degree to zero and then considering each of the following questions in turn:
1. Are the first 3 letters of the input terms the same (and in the same order)? If so, add 0.3 to the matching degree, CF.
2. Are the first four letters of the input terms the same (and in the same order)? If so, add 0.3 to the matching degree, CF.
3. Are the first three letters of the input terms the same (and in the same order) and are the last letters of the input terms (ie the last letter of each) the same? If so, add 0.3 to the matching degree, CF.

Thus if none of the above questions is answered positively the matching degree will remain at zero and the result will be no match. If only one of the above questions is answered positively (ie question 1 only) then there will be a match with a matching degree of 0.3. If two (but not all three) of the questions are answered positively (ie either questions 1 and 2 or questions 1 and 3) then there will be a match with a matching degree of 0.6. Finally, if all three of the questions are answered positively, then there will be a match with a matching degree of 0.9.

The compound name matching rule is used, in the present embodiment, when it is detected that both the terms to be compared are compound names. In that case, a plurality of component atomic names are identified in respect of each term, and an attempt is made to match the first component atomic name of the first term with the first component atomic name of the second term, and then the second component atomic names of the first and second terms etc. until the last component atomic name of the term with the least components has been compared with the corresponding component atomic name in the other term. The attempt to match component atomic names first tries direct matching and then applies the atomic name matching rule if no direct match is found. Having attempted to match the component atomic names, a compound matching degree is calculated according to the following formula:

$$CF ( A , B ) = \frac{{\sum }_{i = 1}^{k} CF ( {a}_{i} , {b}_{i} )}{m + n - {\sum }_{i = 1}^{k} CF ( {a}_{i} , {b}_{i} )}$$

{Compound matching formula}
where CF(aᵢ,bᵢ) is the matching degree of the i'th pair of component atomic names in the compound terms A and B as determined either using the direct matching rule or using the atomic matching rule (and equal to zero if no match was found); m is the number of component atomic names in term A; n is the number of component atomic names in term B; and k is the smaller of m and n.

Having set out the three types of name matching rules, the algorithm employed can be stated in pseudo-code thus:

```
Comment: first process the verb term, A, of the service search request;
FOR each verb node, B=b₁,b₂,...,bₖ, in the stored ontology{
    TRY to find direct match
        IF successful record match;
            NEXT verb node;
        END IF
    IF A and b_{index} are atomic names
        TRY atomic name matching
            IF successful record match;
                NEXT verb node;
            END IF
    ELSE IF A and b_{index} are both compound names
        TRY compound name matching
            IF successful record match;
                NEXT verb node;
            END IF
    END IF
END FOR
```

Comment: Then repeat for the noun term, O, of the service search request FOR each noun node, P=p₁,p₂, . . . ,pⱼ, in the stored ontology

```
    TRY to find direct match
        IF successful record match;
            NEXT verb node;
        END IF
    IF O and p_{index} are atomic names
        TRY atomic name matching
            IF successful record match;
                NEXT verb node;
            END IF
    ELSE IF O and p_{index} are both compound names
        TRY compound name matching
            IF successful record match;
                NEXT verb node;
            END IF
    END IF
END FOR
```

The above pieces of pseudo code essentially say: first take the verb term entered by the user and then loop through all of the verb nodes stored in the ontology to look for a match. In each iteration of the loop first look for a direct match, if found record the fact of the match by placing an entry into a local storage table including the matched noun node and the matching degree. If there is no direct match, see if both the entered verb term and the current verb node are atomic names (in the present invention, a compound name is detected by looking for either one of the punctuation marks space, underscore, hyphen, full-stop, oblique, colon, comma or semicolon separating two strings of letters, or a change in capitalisation in the middle of a string of letters (excluding the first letter) (eg Comm_property, CommProperty, Comm Property)); if so, look for a match using the atomic name matching rule and if found record the fact of the match as mentioned above. If both the entered verb term and the current verb node are compound names (as discussed above) separate the names into their component atomic names and look for a match using the compound name matching rule and if found record the fact of the match as mentioned above. If no match is found at the end of all this, the current iteration is brought to an end without recording any match and a new iteration is commenced with the next verb node.

Note that in the algorithm described above if the entered verb term is an atomic name but the current verb node is compound, or vice versa, no match will be found (except perhaps in exceptional circumstances where a direct match is found). This is not generally considered to be a problem as it is normally better to try to match a compound name with another compound name, etc. Nonetheless, alternative embodiments could operate in an alternative manner by always applying the compound name matching rule unless both names are atomic, etc.

The algorithm for matching the noun term of the service search request to noun nodes in the ontology is the same as that for the verb term and nodes, mutatis mutandis.

Translated Search Request and Link Matching

In overview, this procedure is carried out in the present embodiment in the following manner. Each of the translated service search requests is considered in turn. Using the ontology, a sub-tree of the action node of the translated search request is formed by including all nodes which are the same class as or a sub-class (including sub-sub-class of etc.) of the action node, as well as the action node itself. Each of the entries to the index table stored in the ontology server 10 is then checked to see if its action node is one of the nodes in the sub-tree. If it is, a matching degree is evaluated in a manner described below which takes into consideration the noun terms as well as the relationships in both the translated search request and the stored link information respectively. The evaluated matching degree is then compared with a threshold and if the matching degree exceeds the threshold, the corresponding service record is selected for retrieval and transmission to the user terminal.

The particular way in which the matching degree between a translated search request and a link whose action node falls within the sub-tree of the action node of the translated search request is set out below. In overview, the it is first checked to see if the noun node in the link falls within the sub-tree (derived in the same way as for the action sub-tree, mutatis mutandis) of the noun node of the translated search request. If not, then the matching degree is set to zero and the matching ends. Otherwise, the relationship of the translated search request and that of the link are compared, if they are both the same a relationship comparison score is set to 1. If one is “related-with” but not the other (ie the other is either input-of or output-of) then the relationship comparison score is set to 0.5. If one is input-of and the other is output-of, then the relationship comparison score is set to 0. Finally, the following formula is used to calculate a value for the matching degree:
MatchingDegree=(CF(A)+CF(P)+CF(R))/(6−(CF(A)+CF(P)+CF(R)))
where CF(A) is the degree of matching between the input verb term and the verb node of the translated search request currently under consideration, CF(P) is the degree of matching between the input noun term and the noun node of the translated search request currently under consideration and CF(R) is the relationship comparison score as discussed above (which takes a value of 0, 0.5 or 1). Note therefore that if CF(A)=CF(P)=CF(R)=1 then MatchingDegree=1; if CF(A)=CF(P)=CF(R)=0 then MatchingDegree=0; and if CF(A)=CF(P)=CF(R)=0.5 then MatchingDegree=⅓.

In the present embodiment, the threshold is set at 0.4. However, in alternative embodiments, any matchingDegree evaluation greater than zero could be selected, with only a limited number (eg 10) of selected records actually being finally selected and sent to the user terminal. In any event, the selected records are preferably displayed in order of decreasing MatchingDegree evaluation score.

Worked Example

In order to illustrate the above discussion, an example input search request will now be considered. For the sake of this illustration, it is assumed that there are only two service records stored in the data store 15 with associated links, as entered by the suppliers, of, in the case of the first record, verb node “Sell”, noun node “House” and relationship Output-of (the supplier in this case is an estate agent offering the service of selling houses to prospective house purchasers) and, in the case of the second record, verb node “Buy”, noun node “Motel” and relationship Input-of (the supplier in this case being a large Motel company which is interested in buying motels from motel owners seeking to sell their motel).

The user inputs the search request “Get” (into the verb text box 52) and “Comm_Property” (into the noun text box 51) and selects the Input-of radio button 53. The resulting search request is transmitted to the ontology server where step S10 name matching is performed. In this step, the search request term “get” is directly matched with the verb node “Get” and none other. The search request term “Comm_Property” is not directly matched with any noun node. It is determined that it is a compound name (by the presence of the underscore character) and it is matched via the compound name matching rule to the noun node “Commercial Property” with a matching degree of CF(P)=(0.6+1)/(2+2−(0.6+1))=⅔≈0.67—see the compound matching formula above, the first atomic names “Comm” and “Commercial” being matched together with matching degree 0.6 by virtue of both questions 1 and 2 being answered positively in the atomic name matching rule. The search request term “Comm_Property” is not however matched together with any other noun node in the ontology.

The method then proceeds to step S25 in which a single translated search request is generated with verb node “Get”, noun node “Commercial Property”, relationship Input-of, CF(A)=1, and CF(P)=0.67.

The method then proceeds to step S30 in which an attempt is made to match the translated search request with one of the records stored in the data store 15 by virtue of the table of links. The link for the first record (“Sell”, “House” Output-of) is not matched because the verb node “Sell” is not in the sub-tree of verb node “Get”. However, the link for the second record (“Buy”, “Motel” Input-of) is matched because verb node “Buy” is in the sub-tree of “Get” and the noun node “Motel” is in the sub-tree of “Commercial Property”.
The MatchingDegree=(1+0.67+1)/(6−(1+0.67+1))=0.80

Since in the present embodiment the threshold is set to 0.4, this record is therefore selected and transmitted back to the user terminal 5 at step S40.

In summary therefore, with special reference to FIG. 6, the present embodiment provides a method of storing service description documents in a computerised storage system in which each document is associated with at least one verb ontological node 204 and at least one noun ontological node 254, each verb ontological node having one or more links to other verb ontological nodes and each noun ontological node having one or more links to other noun ontological nodes whereby the verb nodes form a verb space 200 and the noun nodes form a noun space 250 (the verb space and noun space being distinct limited ontologies) and a method of retrieving service description documents from a plurality of service description documents stored in this way comprising the steps of:

controlling a user interface to request from a user at least one verb request term 405 and at least one noun request term 410,

associating the or each verb request term 405 with a corresponding verb node 204 and the or each noun request term 410 with a corresponding noun node 254,

comparing the or each corresponding verb node 204 with the or each verb node 212, 214 associated with each of the stored service description documents,

comparing the or each corresponding noun node 254 with the or each noun node 262, 266 associated with each of the stored service description documents, and

selecting for retrieval zero or more of the stored service description documents on the basis of the comparison steps and controlling the user interface to inform the user of the selected documents to enable the user to retrieve one or more of the selected documents.

Variations

Instead of storing the table of links and references to stored records on an ontology server, the information could be stored in a different location such as, for example, in the same data store as the records themselves are stored. In fact the link information could simply be part of the data records themselves although this would be quite likely to increase the time taken to perform matching between translated search requests and links associated with the stored data records.

Instead of performing atomic name matching in the manner described above, in an alternative embodiment, a number of different rules could be tested for with different matching scores as before, but instead of testing against each rule regardless of success or failure, the tests could be performed starting from the test or tests with the highest score and ending with the test or tests with the lowest score and ceasing to perform further tests as soon as one of the tests is positive. For example, the following three rules could be tested for:
1. Are the first three letters of the input terms the same (and in the same order) and are the last letters of the input terms (ie the last letter of each) the same? If so, set the matching degree, CF, to 0.5 and end atomic matching, else,
2. Are the first four letters of the input terms the same (and in the same order)? If so, set the matching degree, CF, to 0.5 and end atomic matching, else,
3. Are the first 3 letters of the input terms the same (and in the same order)? If so, set the matching degree, CF, to 0.3 and end atomic matching.

In the above described embodiment, the compound name matching algorithm operates by comparing the first atomic name of the first compound word with the first atomic name of the second compound word, the second atomic name of the first compound word with the second atomic name of the second compound word and so on. This can find no match even for compound names which share a large number of atomic names if the ordering is different between the compound names. An alternative compound name matching rule which could be used to overcome this problem is as described below:

Let A={A1, . . . Am}, B={B1, . . . , Bn} be two compound names, where A1, . . . Am are m atomic names for A and B1, . . . , Bn are n atomic names for B respectively. Let C={C1, . . . , Ck} be k atomic names that are matched between A and B, with CF(C)={CF(C1), . . . , CF(Ck)} being the matching degrees. The matching degree of CF(C) can be computed by comparing each atomic name in the first term with each atomic name in the second term and deciding, based upon the results, which atomic names to pair with one another for use in forming the overall complex name matching result. Formally, we have the following algorithm:

| FOR each term Ai ∈ A ={A1, ... Am} | |
|---|---|
| CF(Ai, B) = 0 | |
| bmax = 0 | |
| FOR each term Bj ∈ B = {B1, ..., Bn} | |
| IF | CF(Ai, Bj) > CF(Ai, B) THEN |
| | CF(Ai, B) = CF(Ai, Bj) |
| | bmax = j |

| ENDIF | |
|---|---|
| ENDFOR | |
| IF | CF(Ai, B) > 0 THEN |
| | C <- C + (Ai, Bbmax) |
| | A <- A − Ai |
| | B <- B − Bbmax |

ENDIF
ENDFOR

The algorithm operates by testing each atomic name of the first term A against each atomic name of the second term B; the pair that has the largest matching degree is added into C and removed from A and B respectively. By the time the algorithm finishes, C contains all the matched pairs from A and B.

The matching degree between A and B, CF(A, B), is thereby computed as:

$$CF ( A , B ) = \frac{{\sum }_{i = 1}^{k} CF ( Ci )}{m + n - {\sum }_{i = 1}^{k} CF ( Ci )}$$

1. A method of searching through a plurality of stored documents, the method comprising:
storing the plurality of documents;
storing a representation of an ontology, the ontology comprising a plurality of inter-related nodes and being divided into at least two distinct sub-spaces;
for each of the plurality of documents, storing at least one association with a node of a first distinct sub-space of the ontology and at least one association with a node of a second distinct sub-space of the ontology;
controlling a user interface to permit a user to input up to at least two search terms using free text entry and to associate the or each search term with a respective distinct sub-space of the ontology;
comparing the or each input search term with nodes of the corresponding sub-space only, in order to attempt to determine one or more possible matches or partial matches; and
selecting one or more of the stored documents based on the or each possibly matched or partially matched node and the stored associations between the stored documents and the nodes of the ontology for presentation to the user.

2. A method of storing a plurality of electronic documents comprising:
generating in respect of each electronic document at least one association with a node of a first type of node and at least one association with a node of a second type of node, the nodes belonging to a predetermined ontology which has the property that a sub-tree of a node of a given type contains only nodes of that same given type; and
storing the pair or group of associations generated in respect of a particular document in addition to the document in a digital memory in such a way that the associations can be readily linked to the corresponding document.

3. A method as claimed in claim 1 wherein the first sub-space contains verb nodes or the first type of node is a verb node and the second sub-space contains noun nodes or the second type of node is a noun node.

4. A method as claimed in claim 1 wherein the associations are stored in an index for efficient searching together with an identification of the document to which each pair or group of associations relates.

5. A method as claimed in claim 1 wherein the documents include a natural language description of a service.

6. A method as claimed in claim 1 further comprising generating a relationship identifier identifying one of a finite number of distinct possible relationships between a node within the first sub-space or of the first type and a node of the second sub-space or of the second type and storing said relationship identifier together with the pair or group of associations.

7. A method of retrieving one or more electronic documents from an electronic storage means storing a plurality of electronic documents, the documents having been stored in accordance with the method of claim 2 or any claim when dependent on claim 2, the retrieval method comprising:
receiving an electronic signal representative of a search request including at least a first term associated with a first type of node and at least a second term associated with a second type of node of a predetermined ontology;
comparing the first term with a plurality of nodes of said first type and comparing the second term with a plurality of nodes of said second type and, in the event of determining at least a partial match, attributing a degree of match to each such node;
generating at least one translated search request comprising at least one of said matched nodes of said first type, at least one of said matched nodes of said second type and the degree of match associated with each;
comparing each matched node of the or each translated search request with the corresponding node of the same type identified by the stored pair or group of associations corresponding to each of the stored electronic documents;
selecting documents for retrieval on the basis of the result of the comparison between the translated search request or requests and the stored pair or group of associations; and
outputting an electronic signal representative of, or identifying, the or each selected electronic document.

8. A method of generating a search request for use in the method of claim 7, the search request generating method comprising:
controlling a user interface to request from a user a first term; controlling the user interface to request from the user a second term;
controlling the user interface to request the user to choose one of a plurality of possible relationship types to express the relationship between the first and second terms; and
generating a search request based on the information entered by the user.

9. Apparatus for storing and retrieving electronic documents comprising:
an electronic data store comprising means for storing a plurality of electronic documents;
further electronic data storage means for storing a pair or group of associations associating each electronic document with at least one node of a first type and at least one node of a second type of a predetermined ontology;
request generation means for generating a search request comprising a first term and a second term;
translation means for generating a translated search request or requests by comparing the first term of a search request with nodes of the first type and comparing the second term of the search request with nodes of the second type to find specific nodes which correspond to the terms of the search request; and
comparison means for comparing the or each translated search request with each stored pair or group of associations and selecting those documents for which a sufficiently close match is determined.

10. Apparatus according to claim 9 wherein the electronic data store also comprises the further electronic data storage means.

11. An electronic data store for use in the apparatus of claims 8, the data store storing a plurality of electronic documents and a pair or group of associations associating each electronic document with at least one node of a first type and at least one node of a second type of a predetermined ontology.

12. A computer program for carrying out the method of claim 1.

13. Carrier means carrying the computer program of claim 12.
